(19) United States
(12) Patent Application Publication
(10) Pub. No.: US 2025/0180704 A1
(43) Pub. Date: Jun. 5, 2025

(54) WINDOW COVER FOR LASER RADAR AND LASER RADAR

(71) Applicant: HANGZHOU OLE-SYSTEMS CO., LTD, Hangzhou, Zhejiang (CN)

(72) Inventors: Ou ZHANG, Zhejiang (CN); Ding DING, Zhejiang (CN)

(21) Appl. No.: 18/695,622

(22) PCT Filed: Jun. 24, 2022
(86) PCT No.: PCT/CN2022/101153

§ 371 Date: Feb. 24, 2025

(30) Foreign Application Priority Data
Sep. 26, 2021 (CN) 202111126690.1
Sep. 26, 2021 (CN) 202122360234.5

(51) Int. Cl. G01S 7/481

(52) U.S. Cl. CPC G01S 7/4811

(57) ABSTRACT

The present disclosure provides a window cover for laser radar and a laser radar, wherein the window cover comprises: a light-tight partition plate; a first accommodating part fixedly connected with a first side face of the partition plate, wherein the first accommodating part and the partition plate jointly form a first accommodating space, the first accommodating space is used for accommodating a laser emitting unit of the laser radar, and an outer edge of the partition plate exceeds an outer edge of the first accommodating part on the first side face in a laser emitting direction; and a second accommodating part fixedly connected with a second side face of the partition plate, wherein the second accommodating part and the partition plate jointly form a second accommodating space, the second accommodating space is used for accommodating a laser receiving unit of the laser radar, and the outer edge of the partition plate exceeds an outer edge of the second accommodating part on the second side face in a laser receiving direction. After the above technical scheme is adopted, it can be effectively avoided that the laser light emitted by the laser emitting unit directly enters the laser receiving unit after being scattered by raindrops, so that the laser radar can operate normally in the rain.

### TECHNICAL FIELD

The present disclosure relates to the technical field of laser radar, and in particular to a window cover for laser radar and a laser radar.

### BACKGROUND

With reference to FIGS. 1 and 2, the figures are schematic diagrams of a laser radar and an optical path thereof in the prior art. For the laser radar in the prior art, whether a laser emitting unit and a laser receiving unit are coaxial or heteroaxial, they are usually arranged adjacent to each other in a window cover. This makes it difficult for the laser radar to operate normally in outdoor rain. Because raindrops 400 are attached to the window cover 100 at this moment, the laser light emitted from the laser emitting unit 300 will hit the raindrops 400 when passing through the window cover 100. The raindrops 400 will scatter part of the laser light, so that part of the scattered laser light will be returned to the laser receiving unit 400 again through the window cover 100. Therefore, the radar cannot measure a distance to a target object, but can only measure a distance to the window cover 100, thereby making the radar unable to operate normally.

### SUMMARY

To overcome the above technical defects, a purpose of the present disclosure is to provide a window cover for laser radar and a laser radar with the window cover, which is capable of making the laser radar operate normally in the rain and preventing crosstalk of emitted light to a laser receiving unit.

Disclosed is a window cover for laser radar, wherein the window cover comprises:
a light-tight partition plate;
a first accommodating part fixedly connected with a first side face of the partition plate, wherein the first accommodating part and the partition plate jointly form a first accommodating space, the first accommodating space is used for accommodating a laser emitting unit of the laser radar, and an outer edge of the partition plate exceeds an outer edge of the first accommodating part on the first side face in a laser emitting direction; and
a second accommodating part fixedly connected with a second side face of the partition plate, wherein the second accommodating part and the partition plate jointly form a second accommodating space, the second accommodating space is used for accommodating a laser receiving unit of the laser radar, and the outer edge of the partition plate exceeds an outer edge of the second accommodating part on the second side face in a laser receiving direction.

Also disclosed is a laser radar, comprising: the window cover as described above;
a laser emitting unit arranged in a first accommodating space of the window cover; and
a laser receiving unit arranged in a second accommodating space of the window cover.

Preferably, the laser emitting unit comprises a laser light source and a collimating lens; and
the laser receiving unit comprises an avalanche photodiode and a converging lens.

Preferably, a first distance exists between the laser emitting unit and the partition plate; and
a second distance exists between the laser receiving unit and the partition plate.

Preferably, the laser radar further comprises a rotating unit; and the rotating unit is used for simultaneously driving the laser emitting unit and the laser receiving unit to rotate relative to the window cover.

Preferably, an optical axis of the laser emitting unit is parallel to the partition plate; and
an optical axis of the laser receiving unit is parallel to the partition plate.

Preferably, rotation axes of the laser emitting unit and the laser receiving unit are perpendicular to the partition plate.

After the above technical scheme is adopted, compared with the prior art, the present disclosure has the beneficial effects that the laser emitting unit and the laser receiving unit are separated by the light-tight partition plate, and an edge of the partition plate exceeds edges of the first accommodating part and the second accommodating part in laser emitting and receiving directions. Therefore, it can be effectively avoided that the laser light emitted by the laser emitting unit directly enters the laser receiving unit after being scattered by raindrops, thereby ensuring that the radar can operate normally in outdoor rain and ensuring the stability of radar performance.

### DESCRIPTION OF THE DRAWINGS

FIG. 1 is a schematic diagram of a laser radar with heteroaxial laser emitting unit and laser receiving unit and an optical path of the laser radar in the rain in the prior art;

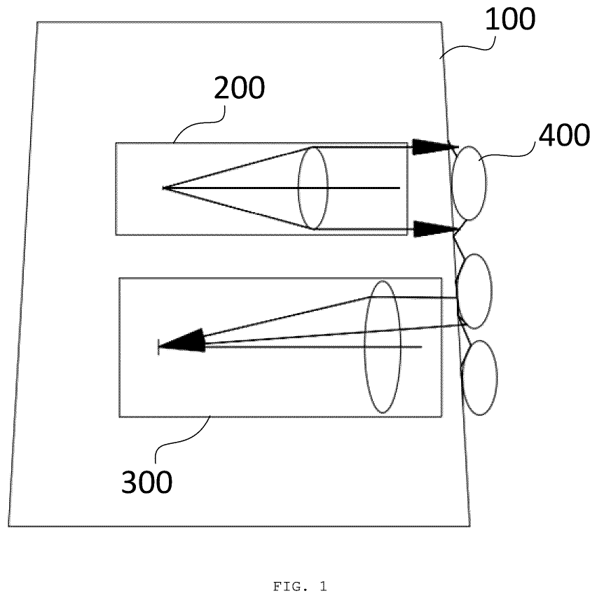

FIG. 2 is a schematic diagram of a laser radar with coaxial laser emitting unit and laser receiving unit and an optical path of the laser radar in the rain in the prior art;

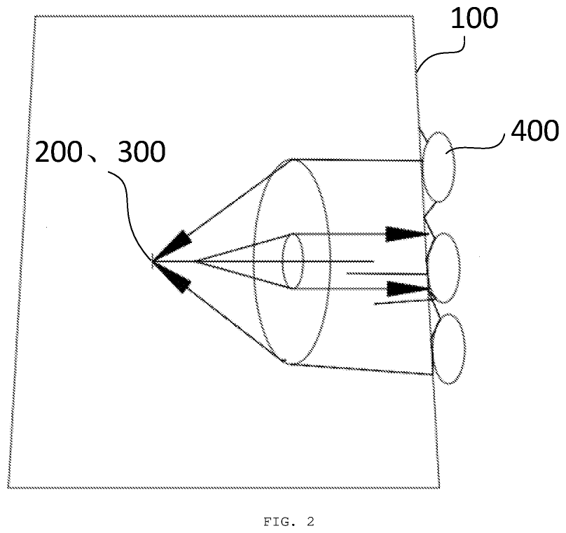

FIG. 3 is a schematic diagram of a laser radar and an optical path thereof in the rain according to an embodiment of the present disclosure.

### REFERENCE NUMERALS

100—window cover, 110—partition plate, 120—first accommodating part, 130—second accommodating part, 200—laser emitting unit, 210—laser light source, 220—collimating lens, 300—laser receiving unit, 310—avalanche photodiode, 320—converging lens and 400—raindrops.

### DETAILED DESCRIPTION

The advantages of the present disclosure are further described below with reference to the drawings and specific embodiments.

Exemplary embodiments will be described in detail here, examples of which are shown in the drawings. When the following description relates to the drawings, the same numbers in different figure represent the same or similar elements unless otherwise indicated. The embodiments described in the following exemplary embodiments do not represent all embodiments consistent with the present disclosure. Rather, they are merely examples of devices and methods consistent with some aspects of the present disclosure as detailed in the appended claims.

The terminology used in the present disclosure is for the purpose of describing particular example embodiments only and is not intended to limit the present disclosure. As used herein, the singular forms, “a”, “an” and “the” are intended to include the plural forms as well, unless the context clearly indicates otherwise. It should also be understood that, as used herein, the term “and/or” means and includes any or all combinations of one or more of the associated listed items.

It should be understood that, although the terms “first”, “second”, “third”, etc. may be used herein to describe various information, the information should not be limited to these terms. These terms may be only used to distinguish the same type of information from each other. For example, a first information could be termed a second information without departing from the scope of the present disclosure and similarly, a second information may also be termed a first information. Depending on the context, the word “if” as used herein can be interpreted as “At the time of . . . ” or “when . . . ” or “in response to a determination”.

It needs to be noted in the description of the present disclosure that the directions or position relationships such as “longitudinal”, “lateral”, “upper”, “lower”, “front”, “rear”, “left”, “right”, “vertical”, “horizontal”, “top”, “bottom”, “inside” and “outside” are based on those in figures, and are used only for facilitating the description of the present disclosure and for simplified description, not for indicating or implying that the target devices or components must have a special direction and be structured and operated at the special direction, thereby they cannot be understood as the restrictions to the present disclosure.

In the description of the present disclosure, unless otherwise specified and limited, it should be noted that the terms “installation”, “connecting” and “connection” shall be understood in a broad sense. For example, they can be mechanical connections or electrical connections, internal communication of two components, or direct connection or indirect connection through an intermediate medium. Those skilled in the art can understand the specific meanings of the above terms according to specific conditions.

In the following description, suffixes such as “module”, “component” or “unit” for denoting elements are used only to facilitate the explanation of the present disclosure and have no particular meaning per se. Therefore, “module” and “component” can be used in a mixed way.

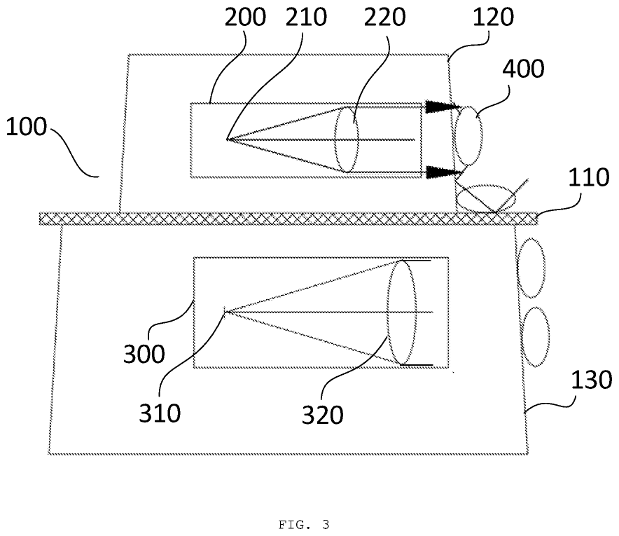

With reference to FIG. 3, which is a structural schematic diagram of a laser radar according to an embodiment of the present disclosure, the laser radar comprises:

### —Window Cover 100

The window cover 100 comprises a light-tight partition plate 110, a first accommodating part 120 and a second accommodating part 130. The first accommodating part 120 is fixedly connected with a first side face of the partition plate 110; the first accommodating part 120 and the partition plate 110 jointly form a first accommodating space; and the first accommodating space is used for accommodating a laser emitting unit 200 of the laser radar. In the present embodiment, the first accommodating part 120 is of an inverted cup shape, with closed top and sides; the bottom has an opening, which is located above the partition plate 110; and the bottom is fixedly connected with the partition plate 110, such as by bolts, to form a closed first accommodating space between the first accommodating part 120 and the partition plate 110. Further, an outer edge of the partition plate 110 exceeds an outer edge of the first accommodating part 120 on the first side face in a laser emitting direction, i.e., a certain distance exists between the outer edge of the partition plate 110 and a bottom edge of the first accommodating part 120 on the partition plate 110; and the distance can be flexibly set according to an overall size of the laser radar. Similarly, the second accommodating part 130 is fixedly connected with a second side face of the partition plate 110 and located below the partition plate 110; the second accommodating part 130 and the partition plate 110 jointly form a second accommodating space; the second accommodating space is used for accommodating a laser receiving unit 300 of the laser radar; and the outer edge of the partition plate 110 exceeds an outer edge of the second accommodating part 130 on the second side face in a laser receiving direction. The first accommodating part 120 and the second accommodating part 130 may be made of plastics, and provided with light-transmitting parts through which the laser light passes on the side faces. The window cover 100 of this application separates the laser emitting unit 200 from the laser receiving unit 300 by the light-tight partition plate 110; and the outer edge of the partition plate 110 exceeds the outer edge of the accommodating parts in the laser emitting and receiving directions, so that it is difficult for the light emitted by the laser emitting unit 200 to directly enter the laser receiving unit 300 through the second accommodating part 130 even if the light is scattered by raindrops 400, and then the laser receiving unit 300 can only receive the laser light returned from a target object, thereby ensuring that the laser radar can operate normally in the rain. Similarly, when the first accommodating part 120 has stains (such as granular dust, fingerprints, and oil stains) on an outer surface, the stains will also scatter the laser light emitted by the laser emitting unit 300. However, for the window cover 100 of this application, it is difficult for the laser light scattered by the stains to directly enter the laser receiving unit 300 through the second accommodating part 130, so that the laser radar can operate normally under this condition.

### —Laser Emitting Unit 200

The laser emitting unit 200 is arranged in the first accommodating space, for emitting laser light; and the emitted laser light passes through the first accommodating part 120 to reach the target object. In the present embodiment, the laser emitting unit 200 comprises a laser light source 210 and a collimating lens 220. Preferably, the laser emitting unit 200 may further comprises a bracket or other optical components for fixing the laser light source 210 and the collimating lens 220. Preferably, in order to prevent the raindrops 400 staying on the partition plate 110 from affecting the laser light emitted by the laser emitting unit 200, a certain distance exists between the laser emitting unit 200 and the partition plate 110, i.e., the laser emitting unit 200 is located at a certain distance above the partition plate 110; and the distance can be flexibly set by the person skilled in the art according to the size of the laser radar.

### —Laser Receiving Unit 300

The laser receiving unit 300 is arranged in the second accommodating space of the window cover 100, for receiving the laser light; and the laser light returned from the target object is received by the laser receiving unit 300 through the second accommodating part 130. In the present embodiment, the laser receiving unit 300 comprises an avalanche photodiode 310 and a converging lens 320. Preferably, the laser receiving unit 300 may further comprises a bracket or other optical components for fixing the laser light source 210 and the collimating lens 220. Preferably, in order to better receive the laser light returned from the target object, a certain distance also exists between the laser receiving unit 300 and the partition plate 110, i.e., the laser emitting unit 200 is located at a certain distance below the partition plate 110; and the distance can be flexibly set by the person skilled in the art according to the size of the laser radar.

In some other embodiments, the laser emitting unit 200 may be arranged in the second accommodating space of the window cover 100; and the laser receiving unit 300 may be arranged in the first accommodating part 120, i.e., a laser reflecting unit is arranged below the partition plate 110, and the laser receiving unit 300 is arranged above the partition plate 110. By adopting such an arrangement, a technical effect of preventing the light emitted by the laser emitting unit 200 from directly entering the laser receiving unit 300 after being scattered by the raindrops 400, so that the radar can also operate normally in the rain.

Preferably, in the present embodiment, the laser radar further comprises:

### —Rotating Unit (not Shown in FIG. 3)

The rotating unit is used for simultaneously driving the laser emitting unit 200 and the laser receiving unit 300 to rotate relative to the window cover 100, to realize target detection in a circumferential direction. Namely, in a state of normal operation of the laser radar, the window cover 100 does not move, and the laser emitting unit 200 and the laser receiving unit 300 rotate circumferentially inside the window cover. The rotating unit comprises a motor and a transmission structure; the motor can be arranged in the first accommodating space or the second accommodating space or the first and second accommodating spaces (realized by forming holes in the partition plate 110); and the laser emitting unit 200 and the laser receiving unit 300 are driven to rotate synchronously by the motor through the transmission structure. In the present embodiment, optical axes of the laser emitting unit 200 and the laser receiving unit 300 are both parallel to the partition plate 110; and rotation axes of the laser emitting unit 200 and the laser receiving unit 300 are perpendicular to the partition plate 110, i.e., the laser emitting unit 200 and the laser receiving unit 300 rotate after being rotated perpendicular to the partition plate 110, so as to realize target detection in a 360-degree direction. In the present embodiment, the partition plate 110 is in a shape of circle; the rotation axes of the laser emitting unit 200 and the laser receiving unit 300 are perpendicular to the partition plate 110 and pass through the center of the circle; the bottom edge of the first accommodating part 120 combined with the upper side of the partition plate 110 is also in a shape of circle, and its center of circle coincides with the center of circle of the partition plate 110; and the top edge of the second accommodating part 130 combined with the lower side of the partition plate 110 is also in a shape of circle, and its center of circle coincides with the center of circle of the partition plate 110. A distance between the bottom edge of the first accommodating part 120 and the edge of the partition plate 110 may or may not be equal to a distance between the top edge of the second accommodating part 130 and the edge of the partition plate 110; and specifically, the person skilled in the art can flexibly set the distance according to the overall design situation of the laser radar.

In the present embodiment, the laser radar comprises the rotating unit, which drives the laser emitting unit 200 and the laser receiving unit 300 to rotate circumferentially relative to the window cover 100. Therefore, the outer edge of the partition plate 110 needs to exceed the outer edge of the first accommodating part 120 on the first side face and the outer edge of the second accommodating part 130 on the second side face in the circumferential direction. For some other embodiments, if the laser emitting unit 200 and the laser receiving unit 300 do not rotate relative to the window cover 100 and are only used for target detection in a fixed direction, the outer edge of the partition plate 110 needs to exceed the outer edge of the first accommodating part 120 on the first side face and the outer edge of the second accommodating part 130 on the second side face in the laser emitting and receiving directions. FIG. 3 is taken as an example, if the laser emitting unit 200 and the laser receiving unit 300 in FIG. 3 do not rotate relative to the window cover 100, the outer edge of the partition plate 110 only needs to exceed the outer edge of the first accommodating part 120 on the first side face and the outer edge of the second accommodating part 130 on the second side face in the right direction, and does not need to exceed the outer edges of the accommodating parts in other directions.

It should be noted that the embodiments of the present disclosure have better implementation, and do not limit the present disclosure in any form. Any person skilled in the art may change or modify the technical content disclosed above into an equivalent effective embodiment without deviating from the content of the technical scheme of the present disclosure. Any modification or equivalent change and modification made to the above embodiments according to the technical essence of the present disclosure still belongs to the scope of the technical scheme of the present disclosure.

1. A window cover for laser radar, wherein the window cover comprises:
a light-tight partition plate;
a first accommodating part fixedly connected with a first side face of the partition plate, wherein the first accommodating part and the partition plate jointly form a first accommodating space, the first accommodating space is used for accommodating a laser emitting unit of the laser radar, and an outer edge of the partition plate exceeds an outer edge of the first accommodating part on the first side face in a laser emitting direction; and
a second accommodating part fixedly connected with a second side face of the partition plate, wherein the second accommodating part and the partition plate jointly form a second accommodating space, the second accommodating space is used for accommodating a laser receiving unit of the laser radar, and the outer edge of the partition plate exceeds an outer edge of the second accommodating part on the second side face in a laser receiving direction.

2. A laser radar, wherein, comprises:
the window cover of claim 1;
a laser emitting unit arranged in a first accommodating space of the window cover; and
a laser receiving unit arranged in a second accommodating space of the window cover.

3. The laser radar of claim 2, wherein
the laser emitting unit comprises a laser light source and a collimating lens; and
the laser receiving unit comprises an avalanche photodiode and a converging lens.

4. The laser radar of claim 2, wherein
a first distance exists between the laser emitting unit and the partition plate; and
a second distance exists between the laser receiving unit and the partition plate.

5. The laser radar of claim 2, wherein
the laser radar further comprises a rotating unit; and the rotating unit is used for simultaneously driving the laser emitting unit and the laser receiving unit to rotate relative to the window cover.

6. The laser radar of claim 5, wherein
an optical axis of the laser emitting unit is parallel to the partition plate; and
an optical axis of the laser receiving unit is parallel to the partition plate.

7. The laser radar of claim 5, wherein
rotation axes of the laser emitting unit and the laser receiving unit are perpendicular to the partition plate.
